(19) United States
(12) Patent Application Publication
(10) Pub. No.: US 2007/0129023 A1
(43) Pub. Date: Jun. 7, 2007

(54) Internet access restriction apparatus

(76) Inventor: Kirk J. Ferrier, Rahway, NJ (US)

Correspondence Address: Mr. Walter J. Tencza Jr., Suite 3, 10 Station Place, Metuchen, NJ, 08840, US

(21) Appl. No.: 11/598,860

(22) Filed: Nov. 14, 2006

Related U.S. Application Data
(63) Continuation-in-part of application No. 10/794,985, filed on Mar. 5, 2004.
Application No. 10/794,985 is a continuation-in-part of application No. 10/155,164, filed on May 23, 2002, now Pat. No. 6,744,863.

(51) Int. Cl. H04B 1/02

(52) U.S. Cl. 455/92

(57) ABSTRACT

A remote transmitter, a receiver, a cable having a first end and a second end, and a solid state switch is disclosed. A first jack is electrically connected to the cable at the first end of the cable, and a second jack is electrically connected to the cable at the second end of the cable. The apparatus may further include a locking clip. The solid state switch may be built into the cable. The locking clip can prevent the first jack from being disconnected from a computer. The first jack and the second jack may be male RJ45 jacks.

### CROSS REFERENCE TO RELATED APPLICATIONS

The present application is a continuation in part of and claims the priority of U.S. patent application Ser. No. 10/794,985, filed on Mar. 5, 2004, which is a continuation in part of and claims the priority of U.S. patent application Ser. No. 10/155,164, filed on May 23, 2002, which issued as U.S. Pat. No. 6,744,863 on Jun. 1, 2004, inventor and applicant Kirk J. Ferrier. The present application claims the priority of both Ser. Nos. 10/794,985 and 10/155,164.

### FIELD OF THE INVENTION

This invention relates to improved methods and apparatus concerning apparatuses and methods for restricting access to the internet.

### BACKGROUND OF THE INVENTION

There are various devices known in the prior art for restricting access to the internet.

### SUMMARY OF THE INVENTION

One or more embodiments of the present invention provide an apparatus comprising a remote transmitter, a receiver, a cable having a first end and a second end, and a solid state switch. The apparatus may include a first jack electrically connected to the cable at the first end of the cable, and a second jack electrically connected to the cable at the second end of the cable. The apparatus may further include a locking clip. The solid state switch may be built into the cable. The locking clip can prevent the first jack from being disconnected from a computer. The first jack and the second jack may be male RJ45 jacks.

One embodiment of the present invention also includes a method of remotely disconnecting or connecting an individual from the internet. The method may include sending an on signal from a remote transmitter in response to actuation of an on button on the remote transmitter, receiving the on signal at a receiver and sending power to a driving circuit of a solid state switch to connect the individual from the internet. The method may also include sending an off signal from the remote transmitter in response to actuation of an off button on the remote transmitter; and receiving the off signal at the receiver and sending power to the driving circuit of the solid state switch to disconnect the individual from the internet.

### BRIEF DESCRIPTION OF THE DRAWINGS

FIG. 1 shows a diagram of an apparatus in accordance with an embodiment of the present invention;

FIG. 2 shows a diagram of another apparatus in accordance with another embodiment of the present invention;

FIG. 3 shows a diagram of circuitry within a receiver of FIG. 1 and an interface module;

FIG. 4 shows a diagram of circuitry within a transmitter of FIG. 1 of an embodiment of the present invention;

### DETAILED DESCRIPTION OF THE DRAWINGS

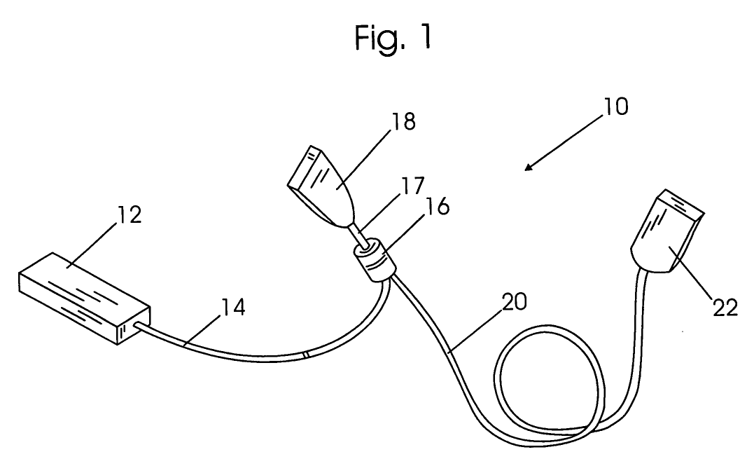

FIG. 1 shows a diagram of an apparatus 10 in accordance with an embodiment of the present invention.

The apparatus 10 includes a receiver 12, a two wire cable 14, a switching device 16, an eight conductor cable 17, an RJ45 connector 18, an eight conductor cable 20, and an RJ45 connector 22. The receiver 12 is connected to a power supply not shown. The switching device 16 has solid state switching in one embodiment of the present invention.

In operation, the RJ45 connector 22 may be connected into an internet source (such as a wallplate, modem, or wireless router, not shown). The RJ45 connector 18 is typically connected into a female RJ 45 jack on the rear of a personal computer. However, the RJ45 connector 18 may be connected to a locking device such as the locking device called MODLOC (trademarked) and then the locking device, not shown may be connected to a personal computer. A locking device, such as the MODLOC (trademarked) locking device, prevents the RJ45 connector 18 from being pulled out of a computer jack of a computer without the LANLOC being cut off. Similarly, the RJ45 connector 22 may be connected to a locking device such as the locking device called LANLOC (trademarked) and then the locking device, not shown may be connected to an internet source (wall plate, etc.). A locking device, such as the LANLOC (trademarked) locking device, prevents the RJ45 connector 22 from being pulled out of an internet source (such as a wall plate, etc.), without the LANLOC being cut off. The locking devices prevent a child, for example, from bypassing the apparatus 10.

The cables 17 and 20 may be Ethernet cables. The cable 20 is connected to a circuit with solid state switching 16, shown in FIG. 1. The cable 20 typically includes eight conductors. One of the eight conductors is a transmit conductor and one of the eight conductors is a receiver conductor. For Ethernet cables, a transmit conductor is often colored green and white, while the receive conductor is often colored orange and white. The switching device 16 is capable of disconnecting (or breaking the connection) between transmit conductors of the cables 17 and 20 and is capable of disconnecting (or breaking the connection) between receive conductors of cables 17 and 20 so that nothing is transmitted from cable 20, through switching device 16, to cable 17 and to RJ connector 18.

When the transmit and receive conductors of cables 17 and 20 are connected by switching device 16, signals come from cable 20 and are passed through solid state relay circuit 16 to RJ45 connector 18. The two wire cable 14 is used as a driving circuit of switching device 16, and does not pass through to connector 18.

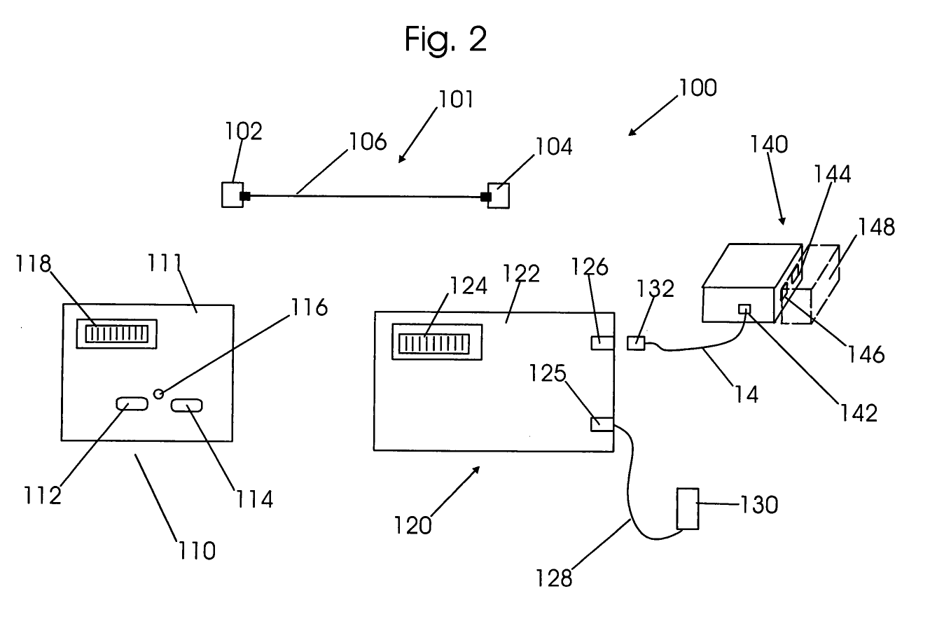

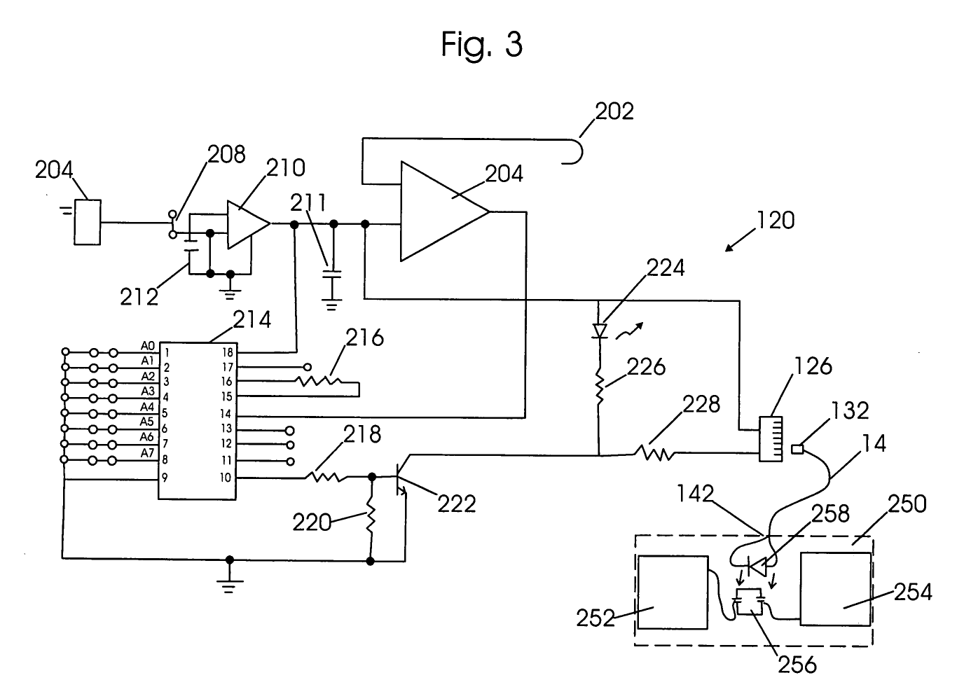

FIG. 2 shows a diagram of an apparatus 100 in accordance with another embodiment of the present invention. The apparatus 100 includes a jumper 101. The jumper 101 may be a one foot long RJ-45 jumper. The jumper 101 includes a connector 102 and a connector 104 electrically connected to opposite ends of a conductor, cable, or wire 106. A module 250, shown in FIG. 3, may be provided in switching device 16. The module 250 may have ports 252 and 254. Connector 104 of jumper 101 can be electrically connected to port 252 and connector 102 of jumper 101 can be electrically connected to cable 17 of FIG. 1. In addition a jumper similar to jumper 101 can be connected to port 254 of module 250. The jumper similar to jumper 101 may have a connector similar to connector 104 which may be electrically connected to port 254 and a connector similar to connector 102 which may be electrically connected to cable 20 of FIG. 1. Alternatively, the jumper 101 may be connected between RJ 45 connector 18 and a computer and a jumper similar to jumper 101 may be connected between RJ45 connector 22 and the internet source.

The apparatus 100 also includes a transmitter 110. The transmitter 110 includes an on button 112, an off button 114, and an activation light emitting diode 116. The activation light emitting diode 116 lights when the on button 112 or the off button 114 is depressed. The transmitter 110 has a housing 111. The apparatus 100 also includes a receiver 120. The receiver 120 includes a housing 122, and a port, connector, or jack 126. The port 126 can be connected to connector 132 of the driving circuit 140. The driving circuit 140 has a port 142 which is connected to connector 132 by cable 134. The driving circuit 140 includes 144, 146, and 148, which are the necessary electronics for this circuitry

The receiver 120 is electrically connected via port 125 and a cable 128 to a transformer 130. The transformer 130 may be a 120 volts AC (alternating current) 60 Hz transformer. The receiver 120 may be a form of the receiver 12 shown in FIG. 1, and may be used in the apparatus 10 shown in FIG. 1.

FIG. 3 shows a circuit diagram of various circuits inside of the housing 122 of the receiver 120 of FIG. 2, as well as two wire cable 14, and an interface module 250. The interface module 250 may be inside of the driving circuit 140 which may be inside of the switching device 16. FIG. 3 shows transmitter coil 202, amplifier 204, transformer 206, switch 208, amplifier 210, capacitor 211, and capacitor 212. FIG. 3 also shows electronic chip 214, resistors 216, and 220, transistor 222, photodiode 224, resistors 226 and 228, and a port, connector, or jack 126. The amplifier 210 may be a 7BL05 amplifier. The transformer 206 may be a 120 volts alternating current 60 Hz transformer. The capacitors 211 and 212 may each be 200 microfarads. The resistors 218 and 220 may each be 2.2 kiloohms. The transistor 222 may be a 2N2222 transistor. The resistors 226 and 228 may each be 510 ohms. The chip 214 may be a digital receiving chip.

FIG. 3 also shows a circuit diagram of the interface module 250 which may be inside of the driving circuit 140 shown in FIG. 2. The interface module 250 includes connector or jack 252 (which can be connected to cable 20 shown in FIG. 1), solid state switching circuit 256, connector or jack 254 (which can be connected to cable 17 shown in FIG. 1), a photodiode 258 (which is connected to two wire cable 14 through port 142).

The end of the two conductor cable 14, may be connector, port or jack 132 shown in FIGS. 2 and 3. The switching device 16 in FIG. 1, may include the driving circuit 140 of FIG. 2, which may include the interface module 250 shown in FIG. 3. The receiver box 12 may be permanently connected to a driving circuit 140 and the photodiode 258 through cable 14, shown in FIG. 3. The circuitry 214 shown in FIG. 3 accepts a signal from a remote transmitter 110 shown in FIG. 2 and the electronics for the driving circuit such as 224, 226, and 228 shown in FIG. 3 of the solid state switching 256 and 258 of FIG. 3.

One of the purposes of the apparatus 10 is to allow parents to disconnect their children from the internet. One of the advantages of the apparatus 10 of the present invention over devices that utilize electromechanical relays as a means of breaking the conductors, is that the output voltage from the receiver 12 sends the appropriate signal to drive the breaking or switching circuit 256 through the through the photodiode 258 of the interface module 250 shown in FIG. 3 and/or in the switching device 16 shown in FIG. 1.

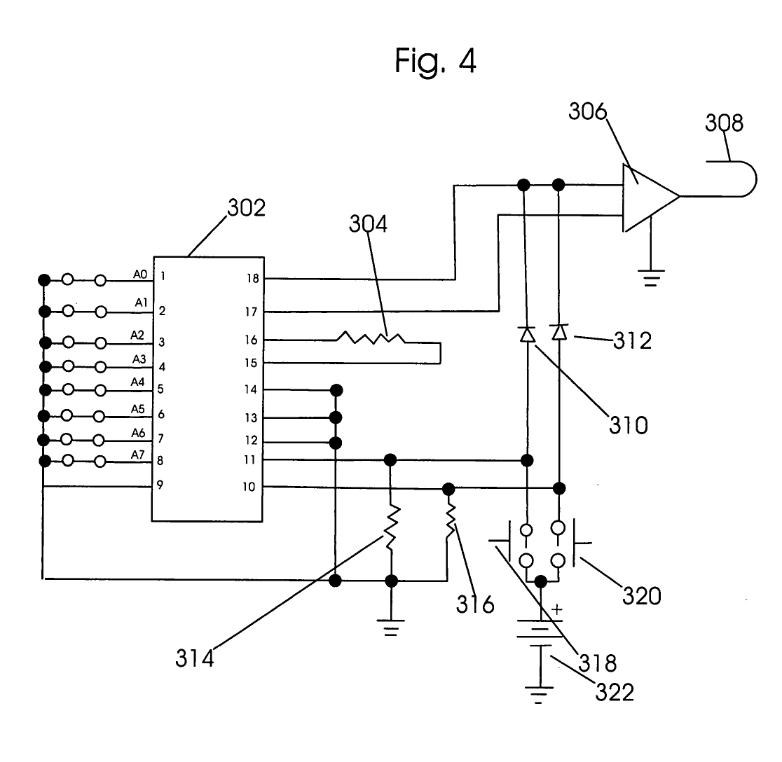

The interface 250 shown in FIG. 3 typically includes a solid state switch including a photodiode 258 and MOS solid state switch 256. The interface 250 is typically not a mechanical relay device. The solid state switch 256 and photodiode 258 in FIG. 3 is a truly electronic device which is comprised of a photo coupled light emitting diode 258 which couples and isolates its signal MOS (Metal Oxide Semiconductor) in which it's state of resistance, high or low, is determined by the light transferred in the optical coupling. The forward bias on the diode 258 turns on the MOS switches 256 to conduct with very low on resistance. The combination offers very fast response times with very low leakage and an exceedingly long life over conventional electromechanical relays. Isolation of the controlling receiver 120 (which may be in receiver 12) and its electronics shown in FIG. 4 through the optical (light) coupling 224 shown in FIG. 3 further enhances the separation to the controlled device from the cable 10 of FIG. 1.

FIG. 4 shows a circuit diagram of electronic circuitry within the transmitter 110. FIG. 4 shows circuit 302, resistor 304, amplifier 306, antenna 308, diodes 310 and 312, resistors 314 and 316, switches 318 and 320, and power source 322. The power source 322 may be 12 volts direct current.

The cables 17 and 20 in FIG. 1 are typically (an Ethernet cable) eight-conductor cables. The circuit 16 is typically a solid state switching device. In operation, the connector 22 is plugged into a modem or wall jack for internet supply (typically through a locking device). The connector 18 is plugged into the back of a computer (typically through a locking device).

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising
a remote transmitter;
a receiver;
a cable having a first end and a second end;
a solid state switch;
a first jack electrically connected to the cable at the first end of the cable; and
a second jack electrically connected to the cable at the second end of the cable; and
a locking clip;
wherein the solid state switch is built into the cable; and
wherein the locking clip can prevent the first jack from being disconnected from a computer.

2. The apparatus of claim 1 wherein
each of the first jack and the second jack is a male RJ45 jack.

3. A method of remotely disconnecting or connecting an individual from the internet comprising
sending an on signal from a remote transmitter in response to actuation of an on button on the remote transmitter;
receiving the off signal at a receiver and sending power to a driving circuit of a solid state switch to connect the individual from the internet;
sending an off signal from the remote transmitter in response to actuation of an off button on the remote transmitter; and
receiving the off signal at the receiver and sending power to the driving circuit of the solid state switch to disconnect the individual from the internet.
